(19) United States
(12) Patent Application Publication
(10) Pub. No.: US 2004/0220974 A1
(43) Pub. Date: Nov. 4, 2004

(54) System for processing data for storage and retrieval

(76) Inventor: Richard Cressman, Malvern, PA (US)

Correspondence Address: Alexander J. Burke, Intellectual Property Department, 5th Floor, 170 Wood Avenue South, Iselin, NJ, 08830, US

(21) Appl. No.: 10/767,031

(22) Filed: Jan. 29, 2004

Related U.S. Application Data
(60) Provisional application No. 60/467,819, filed on May 2, 2003.

(51) Int. Cl. G06F 17/30

(52) U.S. Cl. 707/200

(57) ABSTRACT

Certain exemplary embodiments comprise a method for processing data for storage and retrieval. The method comprises accessing a first physical storage dataset comprising a first end storage address, the first physical storage dataset having a predetermined storage capacity. The method comprises designating a logical dataset comprising a plurality of physical storage datasets, the plurality of physical storage datasets comprising the first physical storage dataset, each of the plurality of physical storage datasets comprising an end storage address, each of the plurality of physical storage datasets having predetermined storage capacities.

### CROSS-REFERENCE TO RELATED APPLICATIONS

This application claims priority to pending U.S. Provisional Patent Application Serial No. 60/467,819 by R. Cressman filed 2 May 2003.

### BACKGROUND

The use and management of information represents a cornerstone of our economy and society. The use of data and databases permeates business and government. In many applications data is electronically stored in a memory and/or retrieved therefrom via an information device. In certain typical applications, information is stored sequentially in a memory. In certain applications, a dataset is used for the storage of information.

Memory in general, and datasets in particular, are characterized by finite storage capacities. Either a physical capacity of a memory or a logical addressability limit inherent in data processing software typically limits storage capacities. Certain applications store information using a single physical dataset.

Certain applications use a batch processing scheme for the processing and storage of data. Batch processing allows information to be separated by, for example, subject matter and/or time. Batch processing can be used to place data in different locations. Batch processing can empty, or reduce the amount of information stored in, certain memory addresses used by application software. In many typical applications, information is copied elsewhere before clearing the information from the memory used by application software.

In certain known systems, application programs abruptly end when the single physical dataset is filled up, thereby presenting a user with an unscheduled interruption to processing. In order to avoid the unscheduled interruption, the user might manually initiate a batch program execution job to flip from a partially full file to an empty one during regular processing times. In doing this, the user sacrifices any ability to operate application software during the file flipping. Neither the unscheduled interruption to processing nor the lost productivity associated with file flipping represents a highly desirable outcome.

### SUMMARY

Certain exemplary embodiments comprise a method for processing data for storage and retrieval. The method comprises accessing a first physical storage dataset comprising a first end storage address, the first physical storage dataset having a predetermined storage capacity. The method comprises designating a logical dataset comprising a plurality of physical storage datasets, the plurality of physical storage datasets comprising the first physical storage dataset, each of the plurality of physical storage datasets comprising an end storage address, each of the plurality of physical storage datasets having predetermined storage capacities.

### DESCRIPTION OF THE DRAWINGS

The wide variety of potential embodiments will be more readily understood through the following detailed description, with reference to the accompanying drawings in which:

FIG. 1 is a flow diagram of an exemplary embodiment of a system 1000 for processing data for storage and retrieval;

FIG. 2 is a block diagram of a method of processing data for storage and retrieval 2000; and.

FIG. 3 is a block diagram of an information device 3000.

### DEFINITIONS

When the following terms are used herein, the accompanying definitions apply:

address—a location of data in a memory device.

Active User Data Area (AUDA)—a collection of data comprising a record written to a logical dataset

capacity—the maximum amount of data that can be contained.

data—numerical or other information represented in a form suitable for processing by an information device.

dataset—a named collection of data in an IBM mainframe operating system.

dataset processor—a processor that maintains a record identifying an end storage address of a first physical storage dataset a logical dataset, sequentially stores data in the logical dataset, monitors the sequential storage of data in the logical dataset to determine occurrence of data storage at a location identified by the end storage address of the individual physical storage dataset, and/or continues the sequential storage of data in a second physical storage dataset of the logical dataset starting at an address subsequent to the end storage address, etc.

ddname—an eight character identifier used by programs to open, process, and/or close a particular dataset.

designation processor—a processor adaptable to create and/or designate a logical dataset on an information device.

Entry Sequenced Data Set (ESDS)—a sequential data set with records that are processed one at a time in the order in which they were loaded. Records are added to the end of the dataset and can be accessed.

index—something that serves to guide, point out, or otherwise facilitate reference.

identifier—a value of a parameter.

information device—a device capable of processing information, such as a general purpose and/or special purpose computer, such as a personal computer, workstation, server, minicomputer, mainframe, supercomputer, computer terminal, laptop, wearable computer, and/or Personal Digital Assistant (PDA), mobile terminal, Bluetooth device, communicator, “smart” phone (such as a Handspring Treo-like device), messaging service (e.g., Blackberry) receiver, pager, facsimile, cellular telephone, a traditional telephone, telephonic device, a programmed microprocessor or microcontroller.

interface—a boundary across which two independent systems meet and act on or communicate with each other. To connect with or interact with by means of an interface.

Input/Output (I/O) device—the input/output (I/O) device of the information device can be any sensory-oriented input and/or output device, such as an audio, visual, haptic, olfactory, and/or taste-oriented device, including, for example, a monitor, display, projector, overhead display, keyboard, keypad, mouse, trackball, joystick, gamepad, wheel, touchpad, touch panel, pointing device, microphone, speaker, video camera, camera, scanner, printer, haptic device, vibrator, tactile simulator, and/or tactile pad, potentially including a port to which an I/O device can be attached or connected.

logical—a user's view of the way data is organized.

machine-readable media—a memory readable by an information device.

memory—the memory of the information device can be any device capable of storing analog or digital information, for example, a non-volatile memory, volatile memory, Random Access Memory, RAM, Read Only Memory, ROM, flash memory, magnetic media, a hard disk, a floppy disk, a magnetic tape, an optical media, an optical disk, a compact disk, a CD, a digital versatile disk, a DVD, and/or a raid array, etc. The memory can be coupled to a processor and can store instructions adapted to be executed by processor according to an embodiment disclosed herein.

network interface—a telephone, a cellular phone, a cellular modem, a telephone data modem, a fax modem, a wireless transceiver, an ethernet card, a cable modem, a digital subscriber line interface, a bridge, a hub, a router, or other similar device.

operating system—a foundational set of machine readable instructions executed on an information device; an operating system can, for example, schedule tasks, allocate storage, and/or present a default interface to a user when no application software is operating, etc.

physical—an operating system's view of the way data is organized.

pointer—a variable that contains the address of a location in memory. The location is the starting point of an allocated object, such as an object or value type, or the element of an array.

processor—any device and/or set of machine-readable instructions adaptable to perform a specific task. A processor comprises any one or combination of hardware, firmware, and/or software adaptable to perform a specific task. A processor acts upon information by manipulating, analyzing, modifying, converting, transmitting the information to an information device, and/or routing the information to an output device. A processor may reside on and use the capabilities of a controller.

record—a collection of data elements. A set of records constitutes a file. For example, a personnel file might contain records that have data elements stored in three fields: a name field, an address field, and a phone number field. A group of records forms a database.

Relative Byte Address (RBA)—an offset from the beginning of a memory or storage area (e.g. an offset within a VSAM dataset where a record begins).

storage—the ability of a device to hold and retain data.

retrieval—an act to obtain data from storage.

storage—a memory device adaptable to hold and retain data. Placing and retaining data in a memory device.

user—a person or software interfacing with an information device operating system.

Virtual Storage Access Method (VSAM)—a file management system used on IBM mainframes.

### DETAILED DESCRIPTION

In certain exemplary embodiments, a system designates multiple physical datasets as a logical dataset e.g. the system uses a series of IBM VSAM ESDS datasets, for example, as a “logical” dataset which is written-to and read-from by application programs executing under IBM's CICS transaction processing product. A “logical” RBA (Relative Byte Address) can be used to enable application programs to randomly access and process data within a “logical” dataset.

System algorithms can be used to: determine the next ddname to use when the current ddname becomes full, determine the physical ddname and physical RBA from the logical RBA and logical ddname, and/or determine the logical RBA and logical ddname from the physical ddname and physical RBA.

The system enables CICS-based applications, for example, to write more than 4 gigabytes of data to a VSAM ESDS logical ddname and process that data without having to empty out the VSAM ESDS dataset when it fills up prior to normal day-end processing and also without utilizing hardware and/or software compression of the data. The system enables back-up storage of data automatically during day-end processing.

A “logical” dataset allows up to 52, gigabytes (or more) of data to be written and processed on a daily basis automatically by CICS-based application programs, for example. In an example, the “logical” dataset is comprised of a set of 13 physical VSAM ESDS datasets, each of which can hold up to 4 gigabytes of data. A method is used to assign ddnames and dataset names and an algorithm (the ddname-pattern algorithm) determines a next sequential ddname and/or dataset name.

The “logical” RBA and “logical” ddname are used, in conjunction with an algorithm (the RBA conversion algorithm), to determine where within the set of 13 physical datasets any given record resides. This allows an application program to go directly to a record using a logical ddname and logical RBA of the record.

The physical RBA and physical ddname are used, in conjunction with this same algorithm, to determine the “logical” RBA and “logical” ddname for any given record.

Once a physical dataset becomes full, the ddname-pattern algorithm is used to derive the next physical ddname to use within the “logical” ddname. This becomes the current physical file being written to.

An application program sequentially browsing through a logical dataset is able to automatically determine a next dataset name to use once the end of the current physical dataset one is reached. This is accomplished using the ddname-pattern algorithm. A CICS-based application is able to write and process up to 52 gigabytes of data to a single logical ddname.

In certain exemplary embodiments, the ddname-pattern algorithm uses the last character of the 8-character ddname to indicate physical files within the same logical file. The letters A, C, E, G, I, K, M, O, Q, S, U, W, and Y comprise one logical set, and B, D, F, H, J, L, N, P, R, T, V, X, and Z comprise another. On a daily basis, the application switches from one logical file set to another. Once the switch has occurred, the inactive logical file set is backed up to tape and physical files are then deleted and redefined empty. This switching is initiated via a batch job run as part of day-end processing. In the described exemplary embodiment, an IBM assembler-based macro was created which, when given the current physical file's eighth character, derives the next character to use in the logical file set.

The last character of the physical dataset name is also used in the same manner as the ddname. Thus, a program needing to derive the next physical dataset name from the current one may use the same macro mentioned above.

The RBA conversion algorithm may either use the logical RBA and logical ddname to determine the physical ddname and physical RBA or use the physical ddname and physical RBA to determine the logical RBA and logical ddname.

In the exemplary embodiment, CICS application programs, in response to a VSAM ESDS dataset becoming full, automatically determine the next physical ddname to use within the logical ddname and continue to write records to storage without operator intervention.

Application programs browsing through a VSAM ESDS dataset may automatically determine the next physical dataset name to process in order to access all records within a logical dataset.

Certain exemplary embodiments use data compression before it is written out to disk, thus achieving more than 4 gigabytes of data in any single dataset. This approach does not allow CICS-based application programs or other programs to process the data randomly.

Certain exemplary embodiments involve using VSAM extended addressability Key Sequenced DataSets (KSDS). A KSDS is one of type of VSAM dataset in which the logical records are placed in sequence according to a key that is part of each record. Usually, each key in a KSDS is unique and is located in the same place in the record. An application program can generate unique keys in an increasing manner, such that each record to be written has a key that is greater, larger, and/or further advanced in the sequence than the previous record. The data can be processed in the order in which the key was created.

The system of extending data storage beyond physical storage boundaries is applicable to any data storage system storing data sequentially and is not restricted to an IBM based environment.

System features can include the use of a “logical” RBA and a “logical” ddname/dataset for storage and access.

In an exemplary IBM environment, a physical infrastructure comprises 26 files divided into two logical sets—set “A” and set “B”. Each file's ddname is comprised of the same first seven characters followed by a one-character suffix. Only the letters “A” through “Z” are currently utilized. Each logical file is thus comprised of 13 physical files. Each file can physically hold four Gigabytes (GB) of data (4,294,967,296), giving a maximum of 53 Gigabytes of data per logical file (55,834,574,848).

Given logical RBA X and RBA Conversion Table Y, determine the physical ddname A where the record resides and the physical RBA B to point at the record within that physical dataset. For example,

```
Set I to 1.
Loop:
    If X < Y1(I)
        Then B = X − Y2 (I)
            A = Y3 (I)
            Exit
    Else I = I + 1
        Goto Loop:
```

RBA Conversion Table Y:

| Y1 | Y2 | Y3 | Y4 |
|---|---|---|---|
| 04294967296 | 00000000000 | A | B |
| 08589934592 | 04294967296 | C | D |
| 12884901888 | 08589934592 | E | F |
| 17179869184 | 12884901888 | G | H |
| 21474836480 | 17179869184 | I | J |
| 25769803776 | 21474836480 | K | L |
| 30064771072 | 25769803776 | M | N |
| 34359738368 | 30064771072 | O | P |
| 38654705664 | 34359738368 | Q | R |
| 42949672960 | 38654705664 | S | T |
| 47244640256 | 42949672960 | U | V |
| 51539607552 | 47244640256 | W | X |
| 55834574848 | 51539607552 | Y | Z |

Given physical ddname A and physical RBA B, determine the logical ddname C and logical RBA D using the above RBA Conversion Table Y. The logical ddname can only have 2 possible values “A” or “B”.

```
Set I to 1.
Loop:
    If A = Y3 (I)
        Then D = B + Y2 (I)
            C = Y3 (1)
            Exit.
    Else
        If A = Y4 (I)
            Then D = B + Y2 (I)
                C = Y4 (1)
                Exit.
        Else
            I = I + 1
            Goto Loop.
```

Given the current physical ddname X, derive the next physical ddname Y to use by using ddname table Z.

```
Set I to 1.
Loop:
    If X = Z1 (I)
        Then X = Z1 (I+1)
        Exit
    Else
        If X = Z2 (I)
            Then X = Z2 (I+1)
                Exit
        Else
            I = I + 1
            Goto Loop.
```

ddname Table Z:

| Z1 | Z2 |
|---|---|
| A | B |
| C | D |
| E | F |
| G | H |
| I | J |
| K | L |
| M | N |
| O | P |
| Q | R |
| S | T |
| U | V |
| W | X |
| Y | Z |

The logical file comprises, for example in the very first record, control information pertaining to the logical RBA of a previously successfully processed record, such as the last previously processed record.

Application program CHPPAPPL writes an AUDA to the current active logical logfile. This will be either LOGFILEA or LOGFILEB depending on the current day-end relative to when the system was installed (e.g. on day 1 it will be “LOGFILEA”, day 2 will be “LOGFILEB”, day 3 will be “LOGFILEA”, etc.). CHPPAPPL calls program OASPLOGX, passing the address of the AUDA and its length as parameters.

Program OASPLOGX maintains in memory location M1 the current active logical logfile ddname and the current active physical logfile ddname. Upon receipt of the above two parameters from program CHPPAPPL, OASPLOGX will attempt to write the AUDA to the current active physical logfile. If the write succeeds, control returns to program CHPPAPPL. If the write fails because the file is out of space, OASPLOGX will use the algorithm described in paragraph [64] to derive the next physical ddname to use in the logical file set. OASPLOGX will then write out the AUDA to that new physical ddname and update memory location M1 to reflect this new active physical ddname.

Program TIF reads and processes data sequentially from the current active logical logfile. Program TIF accesses memory location M1 to obtain the current active logical logfile. Program TIF reads the control information record to obtain the last logical RBA that program TIF processed. Program TIF uses the algorithm described in paragraph [59] to determine the current active physical ddname and physical RBA within that physical ddname. Program TIF reads the record at that location to determine its length. Program TIF adds that length to the physical RBA to determine the RBA of the next unprocessed record. Program TIF reads that record, processes it, increments the logical RBA by the length of that record, and updates the control information record with the new logical RBA.

During day-end processing, all access to the file is suspended. Memory location M1 is updated to reflect the opposite logical ddname from the current logical ddname (i.e. if ‘B’ is the current active, then it is changed to ‘A’), and the current active physical ddname is also updated to this same value (i.e. we always start with the first physical ddname in the logfile file set). Once this switch has occurred, access to the file is allowed, and the newly inactive logical file set is backed up to tape. After the backup is complete, all of the physical files within the logical file set are deleted and redefined as empty.

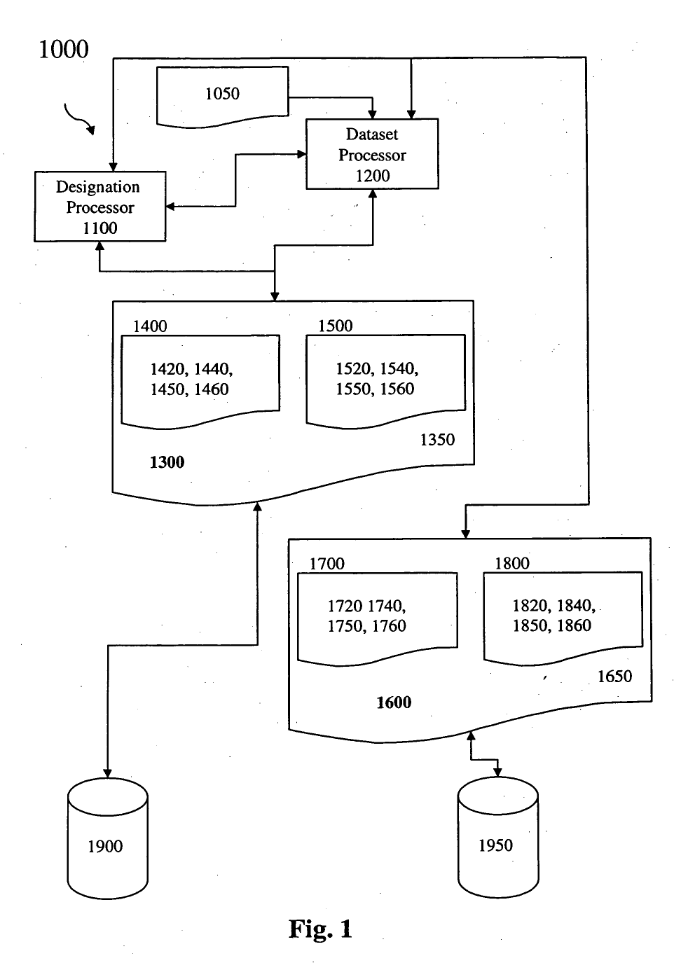

FIG. 1 is a flow diagram of an exemplary embodiment of a system 1000 for processing data 1050 for storage and retrieval and comprising a designation processor 1100. Designation processor 1100 designates a logical dataset, such as a first logical dataset 1300 or a second logical dataset 1600. First logical dataset 1300 comprises a first physical storage dataset 1400 and a second physical storage dataset 1500. Second logical dataset 1600 comprises a third physical storage dataset 1700 and a fourth physical storage dataset 1800. Logical datasets 1300, 1600 can comprise any number of physical storage datasets. Each physical storage dataset 1400, 1500, 1700, 1800 has a predetermined storage capacity 1420, 1520, 1720, 1820. Designation processor 1100 is communicatively coupled to dataset processor 1200. Application programs executing under IBM's CICS transaction processing product comprise designation processor 1100 and dataset processor 1200.

Dataset processor 1200 maintains identifiers identifying end storage addresses 1440, 1540, 1740, 1840 of physical storage datasets 1400, 1500, 1700, 1800. Physical storage datasets 1400, 1500, 1700, 1800 of logical datasets 1300, 1600 comprise an IBM VSAM ESDS, for example. Dataset processor 1200 sequentially stores data 1050 in logical datasets 1300, 1600.

Dataset processor 1200 maintains identifiers of storage capacity used 1350, 1650 in response to storage of data 1050 in logical datasets 1300, 1600. Dataset processor 1200 monitors the sequential storage of data 1050 in logical datasets 1300, 1600 to determine the occurrence of data storage at a location identified by the end storage addresses 1440, 1540, 1740, 1840 of physical storage datasets 1400, 1500, 1700, 1800. Dataset processor 1200 determines the occurrence of data storage at the location identified by the end storage addresses 1440, 1540, 1740, 1840 of physical storage datasets 1400, 1500, 1700, 1800 by using the identifier of storage capacity used 1350, 1650 and a value representing the predetermined storage capacities 1420, 1520, 1720, 1820 of physical storage datasets 1400, 1500, 1700, 1800. Dataset processor 1200 determines the occurrence of data storage at the location identified by the end addresses 1440, 1540, 1740, 1840 of physical storage datasets 1400, 1500, 1700, 1800 by using RBAs 1450, 1550, 1750, 1850. Dataset processor 1200 determines the occurrence of data storage at the location identified by end addresses 1440, 1540, 1740, 1840 of physical storage datasets 1400, 1500, 1700, 1800 by using pointers 1460, 1560, 1760, 1860. After reaching the location identified by an end storage address 1440 of physical storage dataset 1400 dataset processor 1200 sequentially stores data in the next subsequent physical storage dataset 1500, 1800 of logical dataset 1300 and 1600 respectively starting at an address subsequent to the end storage addresses 1440, 1740.

Physical storage datasets 1400, 1500, 1700, 1800 in logical datasets 1300, 1600 are identifiable and addressable using a ddname. Physical storage datasets 1400, 1500, 1700, 1800 in logical datasets 1300, 1600 are addressable using a ddname comprising an alphabetical character. Alphabetical characters used in ddnames for first logical dataset 1300 comprise a first subset of 13 letters. Alphabetical characters used in ddnames for second logical dataset 1600 comprise a second subset of 13 letters. In certain operative embodiments, using alphabetical characters to identify physical storage datasets 1400, 1500, 1700, 1800 in logical datasets 1300, 1600 increases the effective storage capacity of datasets from a physical storage boundary limit (e.g., a roughly 4 gigabyte limit of VSAM ESDS) gigabytes to larger limit (e.g., roughly 52 gigabytes).

The last character of an 8-character ddname is used to indicate all physical datasets 1400,1500, 1700, 1800 within logical datasets 1300, 1600. The letters A, C, E, G, I, K, M, 0, Q, S, U, W, and Y comprise one logical set, and B, D, F, H, J, L, N, P, R, T, V, X, and Z comprise another. On a daily basis, an application program switches from one logical dataset 1300 to another 1600, or vice versa. Once the switch has occurred, the inactive logical dataset set is backed up to tape and all physical files are then deleted and redefined empty. This switching is initiated via a batch job run as part of day-end processing. In the described exemplary embodiment, an IBM assembler-based macro derives the next character to use in logical datasets 1300, 1600 in response to the current physical dataset's eighth character.

The last character of the name of physical storage dataset 1400, 1500, 1700, 1800 is also used in the same manner as the ddname. The logical RBA and/or the logical ddname are used to determine the physical ddname and/or the physical RBA. The physical ddname and/or physical RBA are used to determine the logical RBA and/or the logical ddname.

The physical and/ or logical RBAs and ddnames are used to determine where within a set of, for example, 13 physical datasets any given record resides. This allows an application program to go directly to a record using the ddname and RBA of the record. An application program sequentially browsing through logical datasets 1300, 1600 is able to automatically determine a next dataset name to use once the end of the current physical dataset is reached.

In certain operative embodiments, logical datasets 1300, 1600 comprise 26 files being divided into 2 logical sets—set ‘A’ and set ‘B’. Each file's ddname is comprised of the same first 7 characters followed by a 1-character suffix. The letters ‘A’ through ‘Z’ are currently utilized. Each logical file is thus comprised of 13 physical files. Each file physically holds 4 Gigabytes of data (4,294,967,296), giving a maximum of 53 Gigabytes of data per logical file (55,834,574,848).

Using alphabetical characters in the ddname to delineate physical storage datasets in logical datasets increases effective storage capacities on logical and/or physical memory devices. Certain exemplary embodiments comprise a first memory device 1900 and a second memory device 1950. In certain exemplary embodiments, a single physical device comprises first memory device 1900 and second memory device 1950. In certain exemplary embodiments, a plurality of physical devices comprises first memory device 1900 and second memory device 1950.

In certain operative embodiments data compression is used on logical datasets 1300, 1600 before writing to memory devices 1900, 1950. Using memory compression further increases the storage capacity of logical datasets 1300, 1600. Using memory compression does not allow CICS-based application programs or other programs to process data in logical datasets 1300, 1600 randomly.

Logical datasets 1300, 1600 comprise VSAM extended addressable KSDS datasets, for example. This requires use of an application program to generate a unique key in an increasing manner for each record to be written with a key greater than the last. The data is processed in the order in which it was created. This embodiment involves VSAM Control Interval splits (causing longer response times and increased CPU utilization) and larger amounts of disk space than, for example, VSAM ESDS embodiments.

Extending data storage beyond physical storage boundaries is applicable to any data storage system storing data sequentially and is not restricted to an IBM based environment

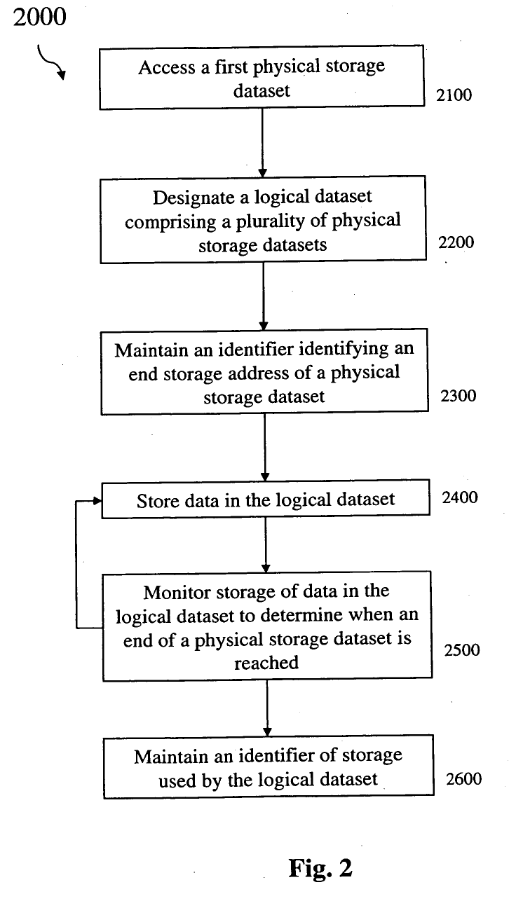

FIG. 2 is a block diagram of a method of processing data for storage and retrieval 2000. In certain exemplary embodiments, at activity 2100, a first physical storage dataset is accessed. The first physical dataset is written to and/or read by application programs, for example, executing under IBM's CICS transaction processing product. The first physical storage dataset comprises information to be used in processing a first logical dataset. At least one physical storage dataset comprises an IBM virtual storage access method entry sequenced dataset (VSAM ESDS).

At activity 2200, a logical dataset is designated. The logical dataset comprises a plurality of physical storage datasets. Using a logical dataset can increase effective storage capacities for dataset processing. The logical dataset enables CICS-based applications, for example, to write more than approximately 4 gigabytes of data to a VSAM ESDS logical ddname and process that data without having to empty out the VSAM ESDS dataset when it fills up prior to normal day-end processing. The logical dataset facilitates improvements for the automatic back-up storage of data during day-end processing.

The logical dataset allows up to approximately 52 gigabytes (or more) of data to be written and processed automatically by CICS-based application programs. In certain exemplary embodiments, the “logical” dataset is comprised of a set of 13 physical VSAM ESDS datasets, each of which holds up to approximately 4 gigabytes of data. Ddnames are assigned to physical storage datasets in the logical dataset and a ddname-pattern algorithm determines a next sequential ddname for a given physical storage dataset.

At activity 2300, an identifier identifying an end storage address of a physical storage dataset is maintained. The identifier is a value stored in a particular address of a memory device. The identifier is one of a plurality of indicators related to one of a plurality of physical storage datasets. In certain exemplary embodiments, the identifier is an RBA. In certain exemplary embodiments, the identifier is a pointer identifying an address location of a particular record in the logical dataset.

At activity 2400, data is stored in the logical dataset. In certain exemplary embodiments, data storage is sequential as in, for example, a VSAM ESDS.

At activity 2500, the storage of data in the logical dataset is monitored to determine when an end of a particular physical storage dataset is reached. Monitoring for the end of a physical storage dataset allows a dataset processing application to use a logical dataset and continue to sequentially store data in another of a plurality of physical storage datasets at an address subsequent to the end of storage address of a particular physical storage dataset once a given physical storage dataset is full. Determining the end storage address of the particular physical storage dataset is performed using an identifier of storage capacity used and a value representing the predetermined storage capacity of the particular physical storage dataset. Once a physical dataset becomes full, the next physical ddname to use within the “logical” ddname is determined. This becomes the current physical file being written to.

In certain exemplary embodiments, CICS application programs, in response to a VSAM ESDS dataset becoming full, automatically determine the next physical ddname to use within the logical ddname and continue to write records to storage without operator intervention. Application programs browsing through a VSAM ESDS dataset may automatically determine the next physical dataset name to process in order to access all records within a logical dataset.

At activity 2600, an identifier is maintained of the amount of storage used by the logical dataset. Monitoring the amount of storage used by the logical dataset allows for an allocation of physical memory device resources to the logical dataset.

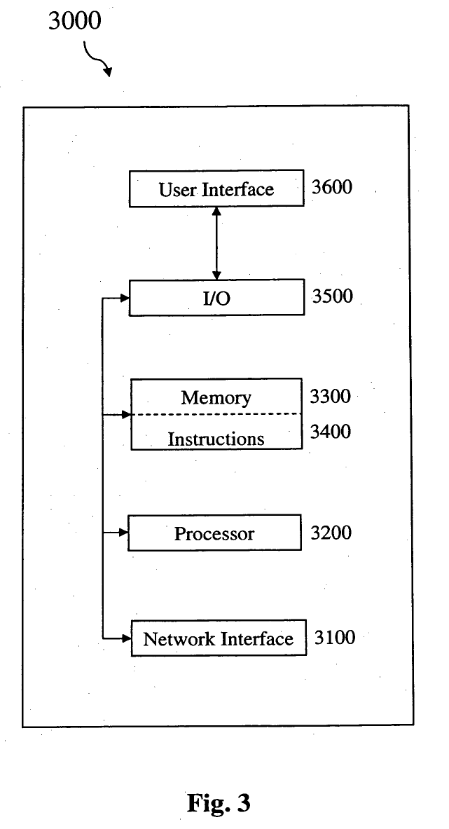

FIG. 3 is a block diagram of an exemplary embodiment of an information device 2000, which in certain operative embodiments comprises, for example, designation processor 1100 and dataset processor 1200 of FIG. 1. In certain exemplary embodiments, information device 3000 comprises any of numerous well-known components, such as for example, one or more network interfaces 3100, one or more processors 3200, one or more memories 3300 containing instructions 3400, one or more input/output (I/O) devices 3500, and/or one or more user interfaces 3600 coupled to I/O device 3500, etc.

Still other embodiments will become readily apparent to those skilled in this art from reading the above-recited detailed description and drawings of certain exemplary embodiments.

What is claimed is:

1. A method for processing data for storage and retrieval, comprising the steps of:
accessing a first physical storage dataset comprising a first end storage address, said first physical storage dataset having a predetermined storage capacity; and
designating a logical dataset comprising a plurality of physical storage datasets, said plurality of physical storage datasets, comprising said first physical storage dataset, each of said plurality of physical storage datasets, comprising an end storage address, each of said plurality of physical storage datasets, having predetermined storage capacities.

2. The method of claim 1, further comprising:
maintaining a plurality of identifiers identifying each end storage address of each physical storage dataset comprised in said plurality of physical storage datasets.

3. The method of claim 1, further comprising:
sequentially storing data in said logical dataset.

4. The method of claim 1, further comprising:
monitoring data storage in said logical dataset to determine an occurrence of data storage at a location identified by one of said end storage addresses of said plurality of physical storage datasets.

5. The method of claim 1, further comprising:
monitoring data storage in said logical dataset to determine an occurrence of data storage at a location identified by one of said end storage addresses of said plurality of physical storage datasets; and
extending the storage of data in a subsequent physical storage dataset of said logical dataset starting at an address subsequent to said one of said end storage addresses of said plurality of physical storage datasets.

6. A method for processing data for storage and retrieval, comprising the steps of:
designating a logical dataset encompassing a plurality of physical storage datasets individually having a predetermined storage capacity;
maintaining an identifier identifying an end storage address of a first physical storage dataset of said logical dataset;
sequentially storing data in said logical dataset;
monitoring said sequential storage of data in said logical dataset to determine an occurrence of data storage at a location identified by said end storage address of said first physical storage dataset; and
continuing said sequential storage of data in a second physical storage dataset of said logical dataset starting at an address subsequent to said end storage address.

7. The method according to claim 6, wherein
said step of monitoring said sequential storage of data in said logical dataset includes the step of maintaining an identifier of storage capacity used in response to storage of data in said logical dataset.

8. The method according to claim 7, wherein
said determination of said occurrence of data storage at said location identified by said end storage address of said first physical storage dataset is performed using said identifier of storage capacity used and said predetermined storage capacity of said first physical storage dataset.

9. The method according to claim 6, wherein
said end storage address of said first physical storage dataset of said logical dataset comprises a relative address.

10. The method according to claim 6, wherein
at least one physical storage dataset comprises an IBM virtual storage access method entry sequenced dataset (VSAM ESDS).

11. The method according to claim 6, wherein
said identifier identifying an end storage address comprises a pointer supporting identifying address locations of particular records in said logical dataset.

12. A system for processing data for storage and retrieval, comprising:
a designation processor adapted to:
designate a logical dataset encompassing a plurality of physical storage datasets individually having predetermined storage capacities; and
a dataset processor adapted to:
maintain an identifier identifying an end storage address of a first physical storage dataset of said logical dataset;
sequentially store data in said logical dataset;
monitor said sequential storage of data in said logical dataset to determine an occurrence of data storage at a location identified by said end storage address of said first physical storage dataset; and
continue said sequential storage of data in a second physical storage dataset of said logical dataset starting at an address subsequent to said end storage address.

13. The system of claim 12, wherein said dataset processor is adaptable to maintain an identifier of storage capacity used in response to storage of data in said logical dataset.

14. The system of claim 12, wherein said dataset processor is adaptable to determine said occurrence of data storage at said location identified by said end storage address of said first physical storage dataset by using an identifier of storage capacity used and said predetermined storage capacity of said first physical storage dataset.

15. The system of claim 12, wherein said end storage address of said first physical storage dataset of said logical dataset comprises a relative address.

16. The system of claim 12, wherein said at least one physical storage dataset comprises an IBM virtual storage access method entry sequenced dataset (VSAM ESDS).

17. The system of claim 12, wherein said identifier identifying an end storage address comprises a pointer supporting identifying address locations of particular records in said logical dataset.

18. A machine-readable media comprising instructions for a plurality of activities comprising:
designating a logical dataset encompassing a plurality of physical storage datasets individually having predetermined storage capacities;
maintaining an identifier identifying an end storage address of a first physical storage dataset of said logical dataset;
sequentially storing data in said logical dataset;
monitoring said sequential storage of data in said logical dataset to determine an occurrence of data storage at a location identified by said end storage address of said first physical storage dataset; and
continuing said sequential storage of data in a second physical storage dataset of said logical dataset starting at an address subsequent to said end storage address.

19. The machine readable medium of claim 18, wherein a physical storage dataset comprises an IBM virtual storage access method entry sequenced dataset (VSAM ESDS).

20. The machine readable medium of claim 18, wherein said end storage address of said first physical storage dataset of said logical dataset comprises a relative address.
